(19) United States
(12) Patent Application Publication
(10) Pub. No.: US 2010/0052831 A1
(43) Pub. Date: Mar. 4, 2010

(54) Relay

(75) Inventor: Satoshi Takano, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 12/585,118

(22) Filed: Sep. 3, 2009

(30) Foreign Application Priority Data
Sep. 4, 2008 (JP) 2008-227471

(51) Int. Cl. H01H 45/04; H01H 45/14

(52) U.S. Cl. 335/202

(57) ABSTRACT

A relay includes a base, a switch built into the base, a first terminal that is built into the base, is connected to one end of the switch, and is provided on a first face of the base, a second terminal that is built into the base, is connected to the other end of the switch, and is provided on the first face, and a third terminal that is connected to the first terminal in the base, and is provided on a second face facing with the first face. A terminal connected to the second terminal in the base is not provided on the second face.

### CROSS-REFERENCE TO RELATED APPLICATION

This application is based upon and claims the benefit of priority of the prior Japanese Patent Application No. 2008-227471, filed on Sep. 4, 2008, the entire contents of which are incorporated herein by reference.

### FIELD

A certain aspect of the embodiments discussed herein is related to a relay.

### BACKGROUND

A relay, in which an electromagnet and a switch operating with the electromagnet are provided on a common base, has been developed for a purpose of opening and closing of high voltage load. Japanese Patent Application Publication No. 2005-71754 discloses a relay including two substrate terminals and two tab terminals that keeps a given insulation distance between an electromagnet and a switch and increases magnetic attractive force of the electromagnet without increasing of external size.

However, the two tab terminals are difficult to distinguish from each other for a user, when one of the substrate terminals and one of the tab terminals of the relay are used. Therefore, the user may insert the other tab terminal into a receptacle in the wrong. In this case, a circuit connected to the relay may get broken.

### SUMMARY

According to an aspect of the present invention, there is provided a relay including a base, a switch built into the base, a first terminal that is built into the base, is connected to one end of the switch, and is provided on a first face of the base, a second terminal that is built into the base, is connected to the other end of the switch, and is provided on the first face, and a third terminal that is connected to the first terminal in the base, and is provided on a second face facing with the first face. A terminal connected to the second terminal in the base is not provided on the second face.

According to another aspect of the present invention, there is provided a relay including a base, a switch built into the base, a first terminal that is built into the base, is connected to one end of the switch, and is provided on a first face of the base, a second terminal that is built into the base, is connected to the other end of the switch, and is provided on the first face, a third terminal that is connected to the first terminal in the base, and is provided on a second face facing with the first face, and a fourth terminal that is connected to the second terminal in the base, and is provided on the second face. Length of the third terminal is different from that of the fourth terminal.

According to another aspect of the present invention, there is provided a relay including a base, a switch built into the base, a first terminal that is built into the base, is connected to one end of the switch, and is provided on a first face of the base, a second terminal that is built into the base, is connected to the other end of the switch, and is provided on the first face, a third terminal that is connected to the first terminal in the base, and is provided on a second face facing with the first face, and a fourth terminal that is connected to the second terminal in the base, and is provided on the second face. One of the third terminal and the fourth terminal is bended.

### BRIEF DESCRIPTION OF DRAWINGS

FIG. 1 illustrates a perspective view of a relay having a tab terminal in accordance with a comparative embodiment;

FIG. 2 illustrates a front view of the relay in accordance with the comparative embodiment;

FIG. 3 illustrates a front view of the relay in accordance with the comparative embodiment viewed from a direction opposite to FIG. 2;

FIG. 4 illustrates a circuit diagram of the relay in accordance with the comparative embodiment;

FIG. 5A and FIG. 5B illustrate a combination in which a substrate terminal is conducted to a tab terminal when a switch of the relay in accordance with the comparative embodiment closes.

FIG. 6A and FIG. 6B illustrate a combination in which a substrate terminal is conducted to a tab terminal whether the switch of the relay in accordance with the comparative embodiment closes or opens;

FIG. 7 illustrates a perspective view of a relay in accordance with a first embodiment;

FIG. 8 illustrates a perspective view of the relay in accordance with the first embodiment;

FIG. 9 illustrates a perspective view of a relay in accordance with a second embodiment;

FIG. 10 illustrates a perspective view of the relay in accordance with the second embodiment;

FIG. 11 illustrates a perspective view of a relay in accordance with a third embodiment;

FIG. 12 illustrates a perspective view of the relay in accordance with the third embodiment; and

FIG. 13 illustrates a perspective view of a relay in accordance with a fourth embodiment.

### DESCRIPTION OF EMBODIMENTS

A description will now be given of embodiments of the present invention with reference to the accompanying drawings. In the following description, the same components have the same reference numerals.

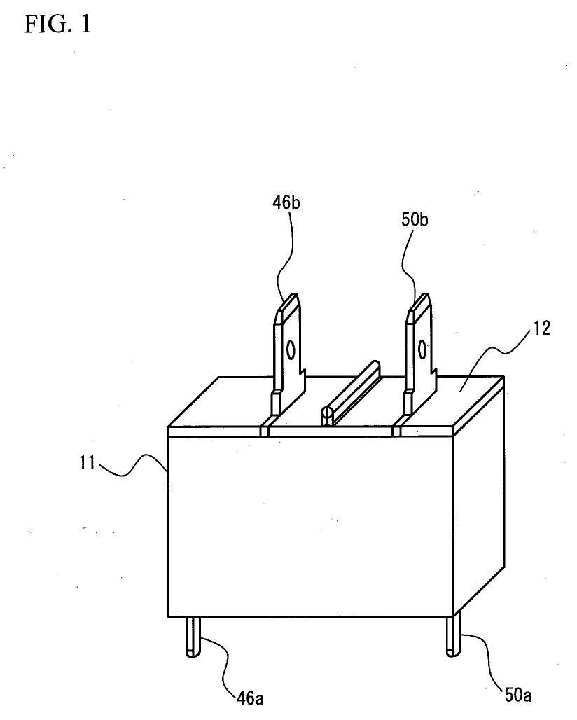

A description will be given of a relay in accordance with a comparative embodiment having two substrate terminals and two tab terminals in order to compare the relay with that of the present invention, with reference to FIG. 1 through FIG. 3.

FIG. 1 illustrates a perspective view of a relay 10 in accordance with the comparative embodiment. The relay 10 includes a base 12, a hollow box 11, substrate terminals 46a and 50a, and tab terminals 46b and 50b. A face of the base 12 where the substrate terminals 46a and 50a are provided acts as a first face. Another face of the base 12 where the tab terminals 46b and 50b are provided acts as a second face. The substrate terminals 46a and 50a are connected to a circuit of a print substrate and act as terminals fixed to the print substrate. The substrate terminals 46a and 50a are, for example, provided on an end portion of the first face as illustrated in FIG. 1 in order to strengthen connection intensity to the print substrate. The tab terminals 46b and 50b are terminals fitted into a receptacle. The tab terminals 46b and 50b are connected to a circuit of another print substrate other than the print substrate to which the substrate terminals 46a and 50a are connected. The tab terminals 46b and 50b are spaced from an end of the second face as illustrated in FIG. 1 in order to fit the tab terminals 46b and 50b into the receptacle.

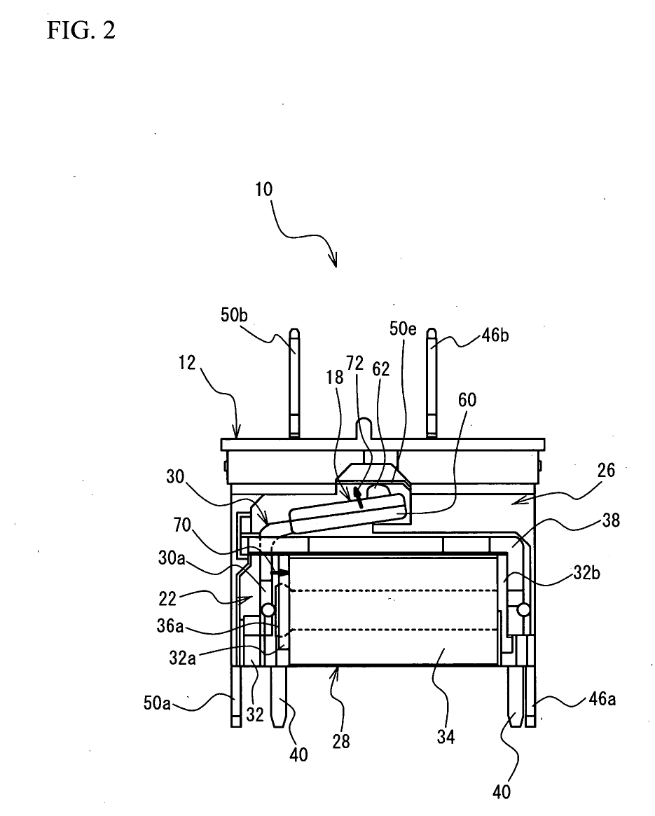

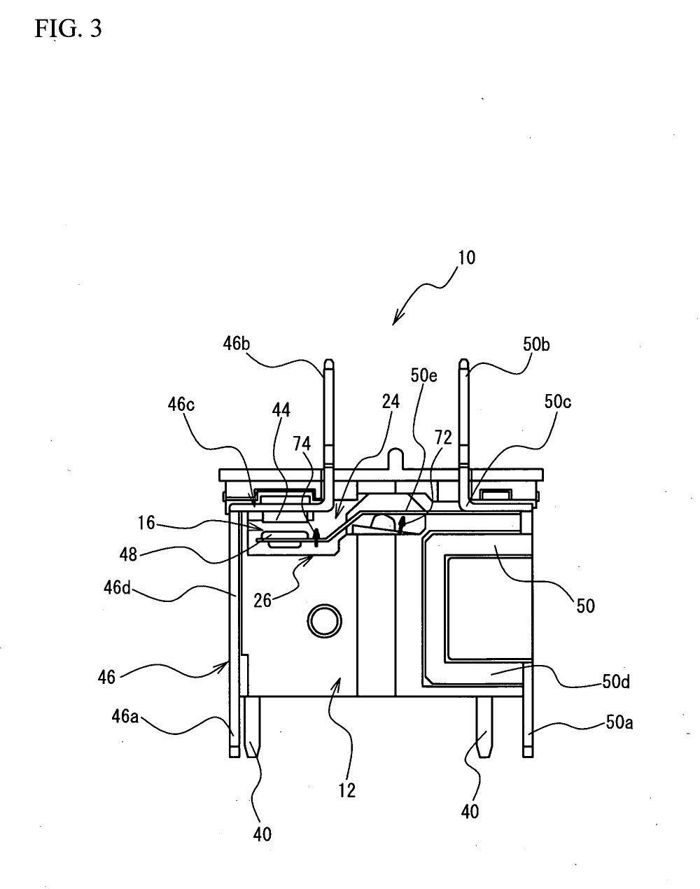

FIG. 2 illustrates an internal view of the relay 10 without the box 11 viewed from one side. FIG. 3 illustrates the internal view of the relay 10 without the box 11 viewed from an opposite side. As illustrated in FIG. 2 and FIG. 3, the relay 10 includes an electromagnet 28, a switch 16 built into the base 12, a fixed contact member 46, and a moving contact member 50. The fixed contact member 46 and the moving contact member 50 are formed with processes in which a conductive board material is punched out into a given shape and is bended. The substrate terminal 46a and the tab terminal 46b are a part of the fixed contact member 46. The substrate terminal 50a and the tab terminal 50b are a part of the moving contact member 50. Therefore, the substrate terminal 46a is conducted to the tab terminal 46b. The substrate terminal 50a is conducted to the tab terminal 50b.

A first end portion of the switch 16 is connected to the fixed contact member 46. A second end portion of the switch 16 is connected to the moving contact member 50. The switch 16 closes when a fixed contact 44 of the fixed contact member 46 contacts a moving contact 48 of the moving contact member 50 with the operation of the electromagnet 28. Details are described later.

The relay 10 has above-mentioned structure. Therefore, the relay 10 may be used with selected one of four combinations of the substrate terminal 46a and the substrate terminal 50a, the tab terminal 46b and the tab terminal 50b, the substrate terminal 46a and the tab terminal 50b, and the substrate terminal 50a and the tab terminal 46b.

A description will be given of each part of the relay 10, with reference to FIG. 2 and FIG. 3.

The base 12 is made of a resin molded component and includes a first concave portion 22 housing the electromagnet 28, a second concave portion 24 housing the switch 16, and a separation wall 26 separating the first concave portion 22 and the second concave portion 24 in an opposite side to each other.

The electromagnet 28 includes a coil frame 32, a coil 34 rolled in the coil frame 32, and an iron core 36a (a region inside of the electromagnet 28 illustrated with a broken line) fixed to the coil frame 32. The coil frame 32 is made of resin molded component having electrical insulation, and includes a hollow body, a pair of guards 32a and 32b connected to both ends of the hollow body in a longitudinal direction thereof, and a pair of coil terminals 40 connected to ends of coil line of the coil.

The coil 34 is rolled around the hollow body of the coil frame 32, and is fixed between the guards 32a and 32b of the coil frame 32. The iron core 36a is, for example, a cylindrical column member made of magnetic steel. A main part of the cylindrical column is housed and fixed in the hollow body of the coil frame 32.

A connection iron 38 forming a magnetic path around the coil 34 is connected and fixed to the iron core 36a of the electromagnet 28 by swaging. The connection iron 38 is, for example, a L-shaped board member made of magnetic steel. A shorter board portion of the L-shaped board member extends along the guard 32b of the coil frame 32. A longer board portion of the L-shaped board member is spaced from a side of the coil 34 and extends in parallel with the coil 34.

An armature 30 is, for example, a L-shaped member made of magnetic steel. One of board portions (a board portion 30a) faces with the iron core 36a. The armature 30 operates with the electromagnet 28. The board portion 30a of the armature 30 is spaced from the iron core 36a by a given distance and is kept still, when the electromagnet 28 is inactive. With magnetic attractive force, the board portion 30a of the armature 30 moves around a bending region thereof in a direction along an arrow 70 approaching the iron core 36a, when the electromagnet is active.

The switch 16 includes the fixed contact member 46 having the fixed contact 44 and the moving contact member 50 having the moving contact 48. The fixed contact member 46 includes the substrate terminal 46a having a pin shape at one end part thereof, the tab terminal 46b having a board shape and extending approximately in parallel with the substrate terminal 46a at the other end thereof, an intermediate portion 46c having a board shape and crossing the substrate terminal 46a and the tab terminal 46b at approximately right angle, and a foot portion 46d having a linear shape and crossing the intermediate portion 46c at approximately right angle between the substrate terminal 46a and the intermediate portion 46c. The fixed contact 44 is made of a given contact member and is fixed to the face of the intermediate portion 46c on the substrate terminal 46a side by swaging.

The moving contact member 50 includes the substrate terminal 50a having a pin shape at one end part thereof, the tab terminal 50b having a board shape and extending approximately in parallel with the substrate terminal 50a at the other end part thereof, an intermediate portion 50c having a board shape and crossing the substrate terminal 50a and the tab terminal 50b at approximately right angle, and a foot portion 50d having a crank shape and crossing the intermediate portion 50c at approximately right angle between the substrate terminal 50a and the intermediate portion 50c. A contact spring element 50e made of thin board such as phosphor bronze for spring is connected to the intermediate portion 50c by swaging. The contact spring element 50e extends in a direction crossing the substrate terminal 50a and the tab terminals 50b at approximately right angle. The moving contact 48 is made of a given contact material and is fixed to the face of free end area of the contact spring element 50e on the tab terminal 50b side by swaging.

The fixed contact member 46 is fixed to the base 12 when the intermediate portion 46c is inserted into the second concave portion 24 of the base 12. The moving contact member 50 is fixed to the base 12 when the intermediate portion 50c and the contact spring element 50e are inserted into the second concave portion 24 of the base 12. The fixed contact 44 and the moving contact 48 are spaced from each other by a given distance and face with each other in a vertical direction in FIG. 3 in the second concave portion 24, when the fixed contact member 46 and the moving contact member 50 are fixed to an adequate position on the base 12.

An operation member 18 is a board-shaped member having a bag structure integrally formed of insulating resin material, and is fixed to one of the extending portions of the armature 30 that is farther from the iron core 36a of the electromagnet 28. The operation member 18 includes a projection 62 projecting outward in an opposite side of a housing portion 60. The operation member 18 moves in a direction of an arrow 72 or the reverse direction, in conjunction with swinging operation of the armature 30 according to excitation or non-excitation of the electromagnet 28.

A description will be given of an closing operation of the switch 16, with reference to FIG. 2 and FIG. 3.

When the electromagnet is active, the board portion 30a of the armature 30 moves with the magnetic extraction force in the direction of the arrow 70 approaching the iron core 36a against spring force of the contact spring element 50e. Accordingly, the operation member 18 presses the contact spring element 50e, moves toward the boundary of swing motion range, and is elastically bended in the direction of the arrow 72 so that the contact spring element 50e approaches the fixed contact member 46. The operation member 18 gets to the boundary of the swing motion range when the board portion 30a of the armature 30 adsorbs onto the iron core 36a completely. The moving contact 48 shifts in the direction of an arrow 74 according to the operation of the operation member 18 and the armature 30, and is conducted to the facing fixed contact 44. Thus, the switch 16 closes.

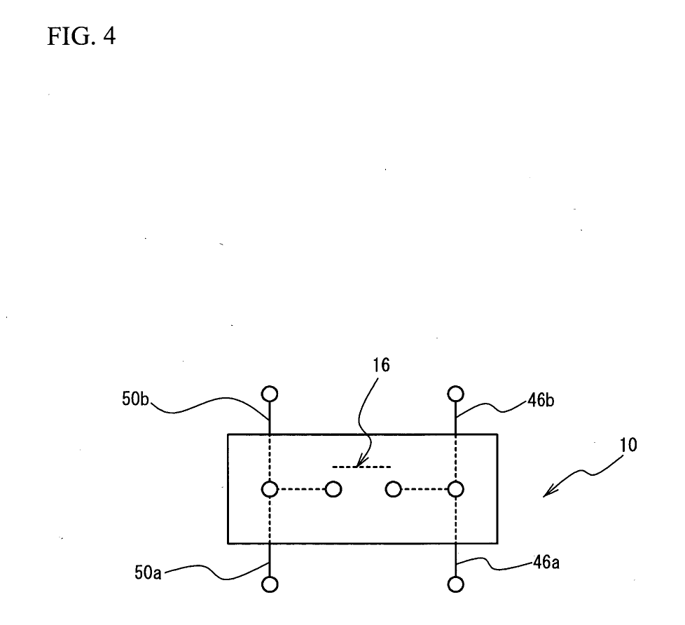

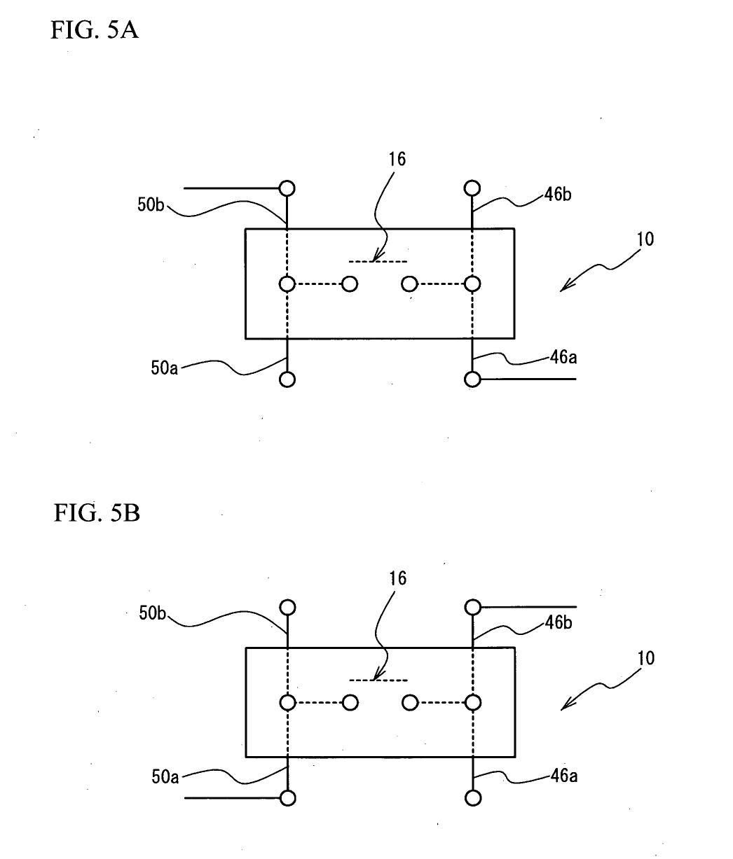

A description will be given of a combination in which one of the substrate terminals is conducted to one of the tab terminals, in a case where the switch 16 of the relay 10 closes, with reference to FIG. 4, FIG. 5A and FIG. 5B.

FIG. 4 illustrates a circuit diagram of the relay 10. The relay 10 includes the substrate terminals 46a and 50a, the tab terminals 46b and 50b, and the switch 16, as illustrated in FIG. 4. The switch 16 is a make contact operating with an electromagnet. The switch 16 closes when the electromagnet is active.

FIG. 5A and FIG. 5B use the circuit diagram of the relay 10 of FIG. 4, and illustrate a combination in which one of the substrate terminals is conducted to one of the tab terminals when the switch 16 of the relay 10 closes. As illustrated in FIG. 5A and FIG. 5B, a combination of the substrate terminal 46a and the tab terminal 50b and a combination of the substrate terminal 50a and the tab terminal 46b are conducted, when the switch 16 closes.

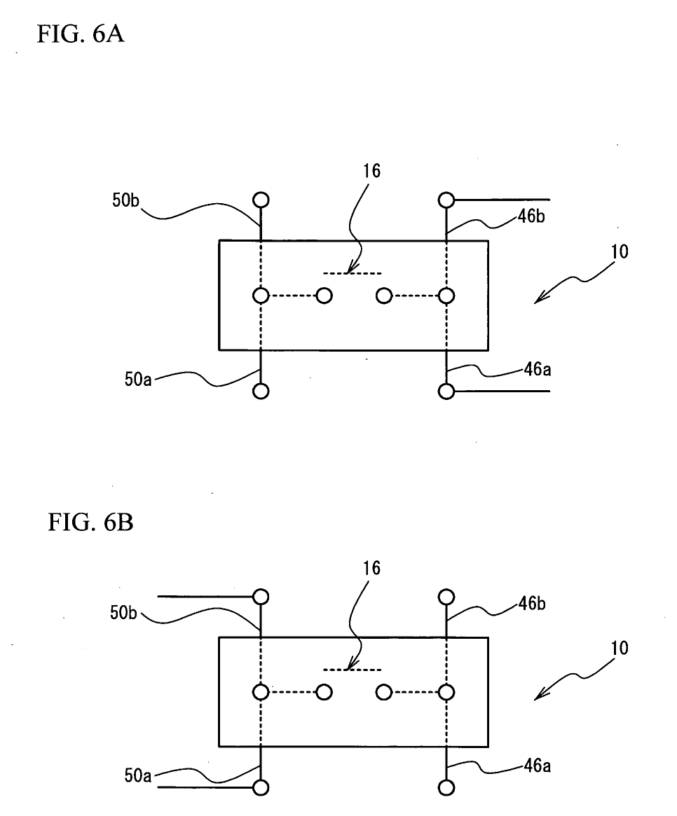

FIG. 6A and FIG. 6B illustrate a combination in which a substrate terminal is constantly conducted to a tab terminal whether the switch 16 of the relay 10 closes or not. As illustrated in FIG. 6A and FIG. 6B, a combination of the substrate terminal 46a and the tab terminal 46b and a combination of the substrate terminal 50a and the tab terminal 50b are constantly conducted, whether the switch 16 closes or not. These combinations of the relay 10 are improper. As illustrated in FIG. 2 and FIG. 3, the substrate terminal 46a and the tab terminal 46b are a part of the fixed contact member 46. The substrate terminal 50a and the tab terminal 50b are a part of the moving contact member 50. Therefore, these combinations are constantly conducted.

The tab terminal 46b and the tab terminal 50b of the relay 10 have the same length and the same shape, and are arranged on a similar position. The tab terminal 46b and the tab terminal 50b are difficult to distinguish for a user. There is a case where the user selects incorrect one of the tab terminals and inserts the tab terminal into a receptacle in the wrong when one of the substrate terminals and one of the tab terminals are used with the relay 10 being fixed to a print substrate. In this case, the substrate terminal is connected to the tab terminal as illustrated in FIG. 6A and FIG. 6B. Thus, a circuit connected to the relay 10 may be inoperative and may be broken because of heating.

A description will be given of embodiments solving the problem of the comparative embodiment, with reference to the following drawings. Explanations of the same components as the comparative embodiment are omitted.

### First Embodiment

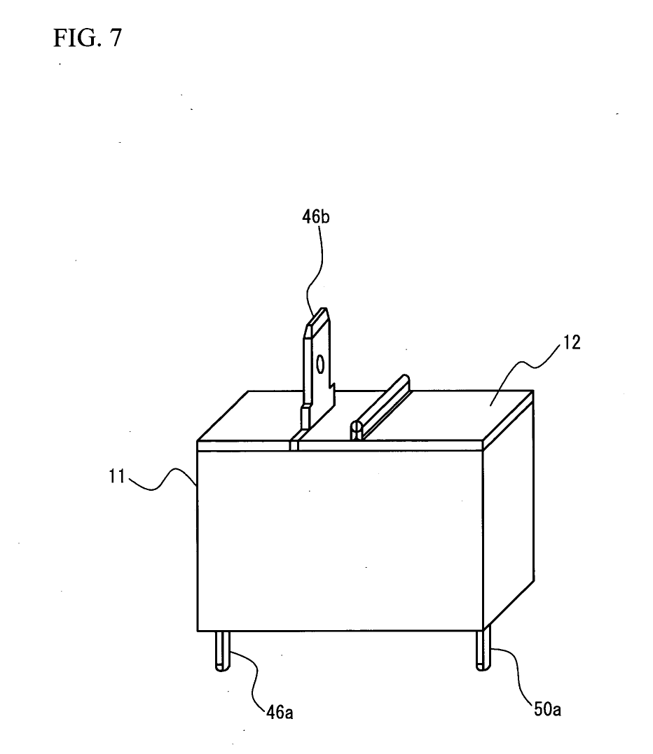

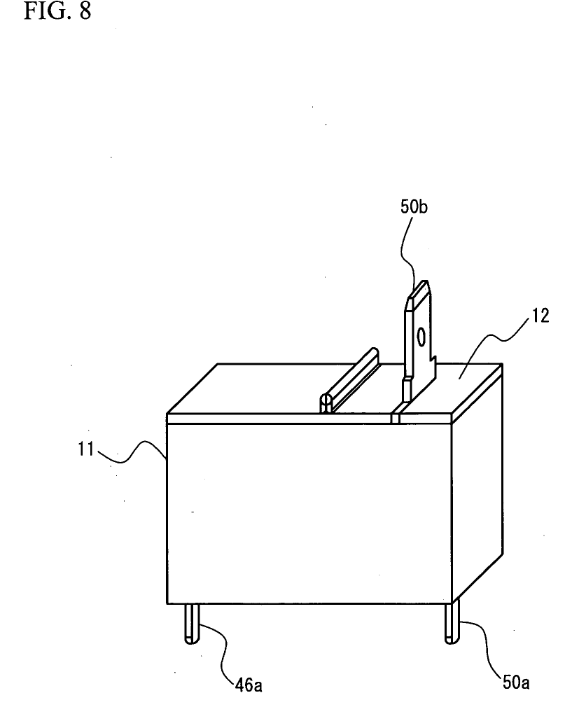

FIG. 7 and FIG. 8 illustrate a perspective view of a relay in accordance with a first embodiment. As illustrated in FIG. 7, the relay in accordance with the first embodiment includes the tab terminal 46b that is connected to the substrate terminal 46a in the base 12 and is provided on the second face facing with the first face, being different from the comparative embodiment. A terminal connected to the substrate terminal 50a in the base 12 is not provided on the second face. As illustrated in FIG. 8, the relay in accordance with the first embodiment includes the tab terminal 50b that is connected to the substrate terminal 50a in the base 12 and is provided on the second face facing with the first face, being different from the comparative embodiment. A terminal connected to the substrate terminal 46a in the base 12 is not provided on the second face.

With the structure, a user does not select the incorrect one. Thus, the incorrect tab terminal is not inserted into the receptacle. Therefore, improper use of the tab terminal of the relay is restrained. And a failure of a circuit connected to the relay is restrained.

In accordance with the first embodiment, the relay includes the tab terminal that is connected to one of the substrate terminals in the base 12 and is provided on the second face. That is, only one of the tab terminals 46b and 50b is provided on the second face. Therefore, the improper use of the tab terminal is restrained. And, the failure of the circuit connected to the relay is restrained.

### Second Embodiment

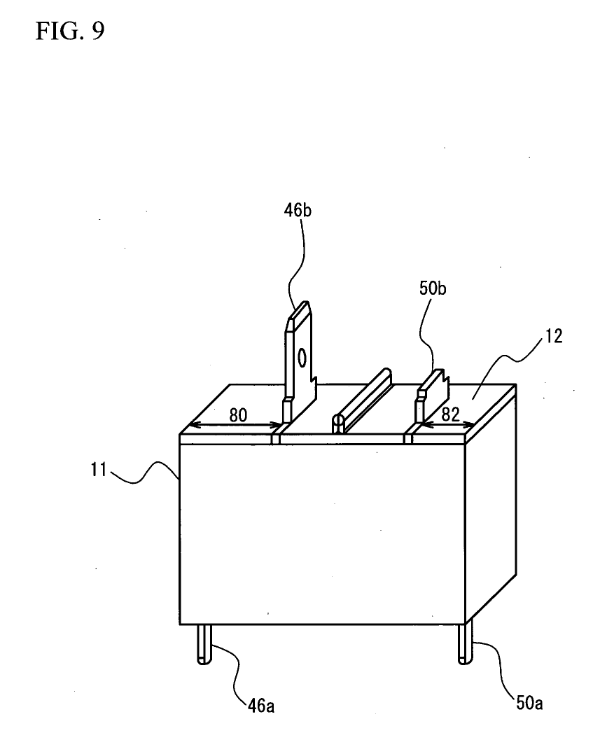

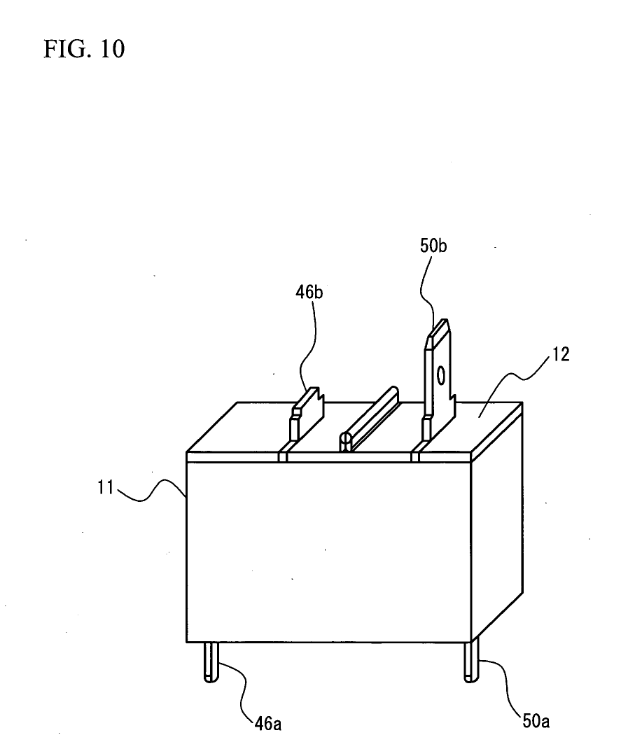

FIG. 9 and FIG. 10 illustrate a perspective view of a relay in accordance with a second embodiment. As illustrated in FIG. 9, in the relay in accordance with the second embodiment, an end part of the tab terminal 50b is cut off, and the length of the tab terminal 46b is different from that of the tab terminal 50b, being different from the comparative embodiment. As illustrated in FIG. 10, in the relay in accordance with the second embodiment, an end part of the tab terminal 46b is cut off, and the length of the tab terminal 46b is different from that of the tab terminal 50b.

The improper use of the tab terminal of the relay is restrained, because a user can distinguish between the two tab terminals 46b and 50b based on the length. Therefore, a failure of a circuit connected to the relay is restrained.

As illustrated in FIG. 9, in the relay in accordance with the second embodiment, a distance 80 between the tab terminal 46b and one end of the second face where the tab terminal is provided is different from a distance 82 between the tab terminal 50b and the other end of the second face where the tab terminal is provided.

Therefore, the improper use of the tab terminal of the relay is restrained because a user can distinguish between the two tab terminals 46b and 50b based on the position in addition to the length. Therefore, the failure of the circuit connected to the relay is restrained.

In accordance with the second embodiment, the length of the tab terminal 46b is different from that of the tab terminal 50b. Therefore, the improper use of the tab terminal of the relay is restrained. Therefore, a failure of a circuit connected to the relay is restrained.

### Third Embodiment

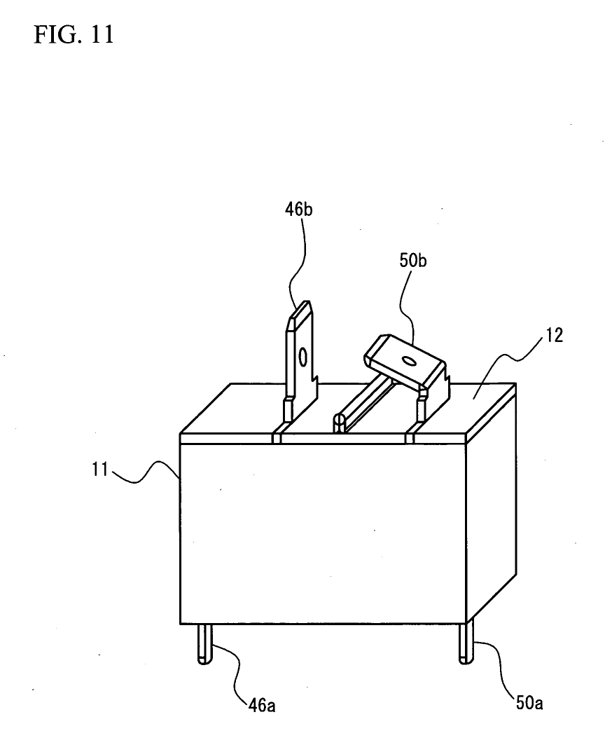

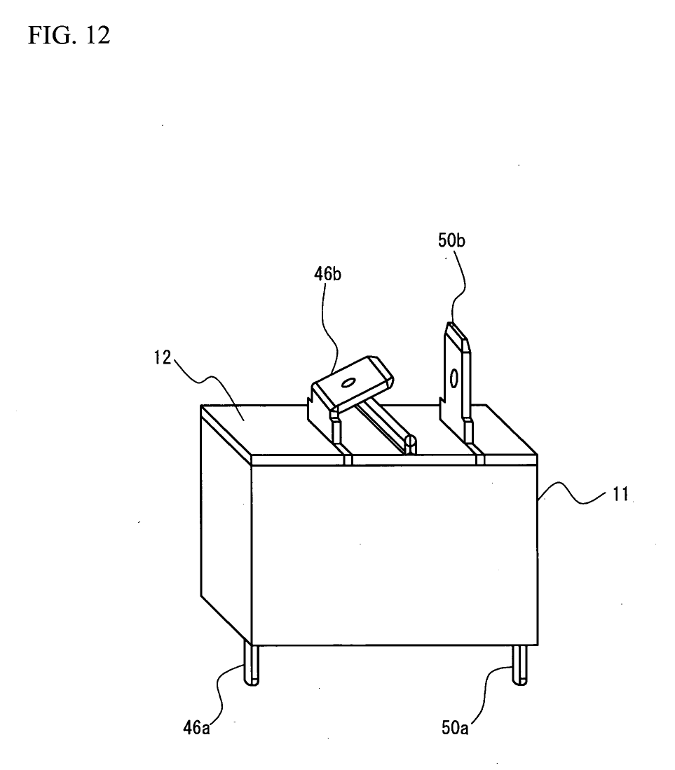

FIG. 11 and FIG. 12 illustrate a perspective view of a relay in accordance with a third embodiment. As illustrated in FIG. 11, in the relay in accordance with the third embodiment, the tab terminal 50b is bended, being different from the comparative embodiment. As illustrated in FIG. 12, in the relay in accordance with the third embodiment, the tab terminal 46b is bended, being different from the comparative embodiment.

Therefore, the improper use of the tab terminal of the relay is restrained because a user can distinguish between the two tab terminals 46b and 50b based on the shape. Therefore, the failure of the circuit connected to the relay is restrained.

In accordance with the third embodiment, one of the tab terminals 46b and 50b is bended. Therefore, the improper use of the tab terminal of the relay is restrained. Therefore, the failure of the circuit connected to the relay is restrained.

### Fourth Embodiment

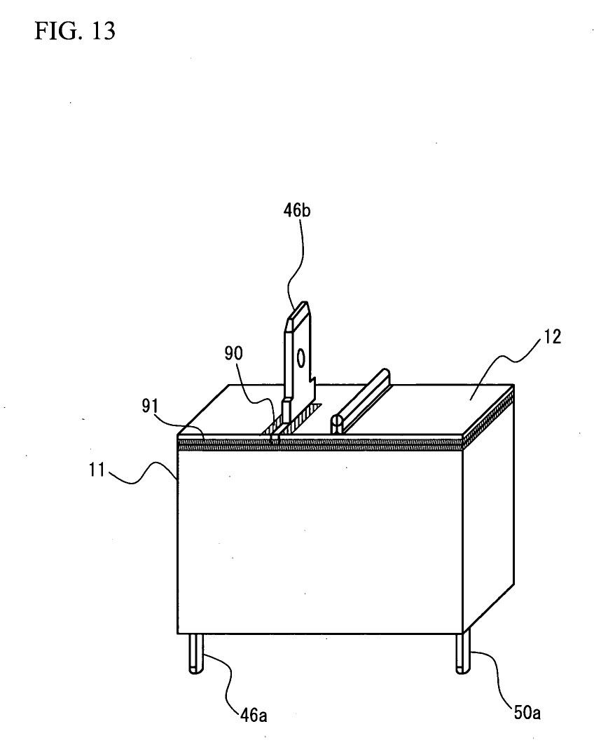

FIG. 13 illustrates a perspective view of a relay in accordance with a fourth embodiment. As illustrated in FIG. 13, the relay in accordance with the fourth embodiment is different from the relay in FIG. 7 in a point that a space between the base 12 and the tab terminal 46b is filled with an adhesive agent. And a space between the base 12 and the box 11 is filled with an adhesive agent. Therefore, the improper use of the tab terminal of the relay is restrained. And, a failure of the relay is restrained because intrusion of such as dust, salt, or corrosive gas into the inside of the relay is restrained. Therefore, the failure of the circuit connected to the relay is restrained.

In the fourth embodiment, the adhesive agent is filled between the base 12 and the tab terminal 46b acting as the third terminal and between the box 11 and the base 12 in the relay illustrated in FIG. 7. The adhesive agent may be filled one of between the base 12 and the tab terminal 46b acting as the third terminal and between the box 11 and the base 12. The adhesive agent may be filled between the base 12 and the tab terminal 50b and between the box 11 and the base 12 in the relay illustrated in FIG. 8. The adhesive agent may be filled one of between the base 12 and the tab terminal 50b and between the box 11 and the base 12 in the relay illustrated in FIG. 8. The adhesive agent may be filled between the base 12 and the tab terminal 46b and between the box 11 and the base 12 in the relays illustrated in FIG. 9 through FIG. 12. The adhesive agent may be filled one of between the base 12 and the tab terminal 46b and between the box 11 and the base 12 in the relays illustrated in FIG. 9 through FIG. 12.

In the second embodiment, the distance 80 between the tab terminal 46b and the end of the face where the tab terminal is provided is different from the distance 82 between the tab terminal 50b and the end of the face where the tab terminal is provided. Similarly, in the third embodiment and the fourth embodiment, a distance between the tab terminal 46b and the end of the face where the tab terminal is provided is different form that between the tab terminal 50b and the end of the face where the tab terminal is provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A relay comprising:
a base;
a switch built into the base;
a first terminal that is built into the base, is connected to one end of the switch, and is provided on a first face of the base;
a second terminal that is built into the base, is connected to the other end of the switch, and is provided on the first face; and
a third terminal that is connected to the first terminal in the base, and is provided on a second face facing with the first face,
wherein a terminal connected to the second terminal in the base is not provided on the second face.

2. A relay comprising:
a base;
a switch built into the base;
a first terminal that is built into the base, is connected to one end of the switch, and is provided on a first face of the base;
a second terminal that is built into the base, is connected to the other end of the switch, and is provided on the first face;
a third terminal that is connected to the first terminal in the base, and is provided on a second face facing with the first face; and
a fourth terminal that is connected to the second terminal in the base, and is provided on the second face,
wherein length of the third terminal is different from that of the fourth terminal.

3. A relay comprising:
a base;
a switch built into the base;
a first terminal that is built into the base, is connected to one end of the switch, and is provided on a first face of the base;
a second terminal that is built into the base, is connected to the other end of the switch, and is provided on the first face;
a third terminal that is connected to the first terminal in the base, and is provided on a second face facing with the first face; and
a fourth terminal that is connected to the second terminal in the base, and is provided on the second face,
wherein one of the third terminal and the fourth terminal is bended.

4. The relay as claimed in claim 2, wherein a distance between the third terminal and an end of the second face is different from a distance between the fourth terminal and an end of the second face.

5. The relay as claimed in claim 3, wherein a distance between the third terminal and an end of the second face is different from a distance between the fourth terminal and an end of the second face.

6. The relay as claimed in claim 1, wherein an adhesive agent is filled at least one of between the base and the third terminal and between the base and a hollow box covering a face of the base other than the first face and the second face.

7. The relay as claimed in claim 2, wherein an adhesive agent is filled at least one of between the base and the third and fourth terminals and between the base and a hollow box covering a face of the base other than the first face and the second face.

8. The relay as claimed in claim 3, wherein an adhesive agent is filled at least one of between the base and the third and fourth terminals and between the base and a hollow box covering a face of the base other than the first face and the second face.

9. The relay as claimed in claim 4, wherein an adhesive agent is filled at least one of between the base and the third and fourth terminals and between the base and a hollow box covering a face of the base other than the first face and the second face.

10. The relay as claimed in claim 1, wherein the switch operates with an electromagnet built into the base.

11. The relay as claimed in claim 2, wherein the switch operates with an electromagnet built into the base.

12. The relay as claimed in claim 3, wherein the switch operates with an electromagnet built into the base.

13. The relay as claimed in claim 1, wherein the first terminal and the second terminal are connected to a print substrate.

14. The relay as claimed in claim 2, wherein the first terminal and the second terminal are to be connected to a print substrate.

15. The relay as claimed in claim 3, wherein the first terminal and the second terminal are to be connected to a print substrate.

16. The relay as claimed in claim 1, wherein the third terminal is fitted into a receptacle.

17. The relay as claimed in claim 2, wherein the third terminal and the fourth terminal are fitted into a receptacle.

18. The relay as claimed in claim 3, wherein the third terminal and the fourth terminal are fitted into a receptacle.
